(19) United States
(12) Patent Application Publication
(10) Pub. No.: US 2005/0078070 A1
(43) Pub. Date: Apr. 14, 2005

(54) System and method for driving a display panel of mobile terminal

(75) Inventor: Jin-Woo An, Gyeonggi-Do (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017, US

(73) Assignee: LG Electronics Inc.

(21) Appl. No.: 10/961,809

(22) Filed: Oct. 8, 2004

(30) Foreign Application Priority Data
Oct. 8, 2003 (KR) 70005/2003
Oct. 13, 2003 (KR) 71143/2003

(51) Int. Cl. G09G 3/30; G09G 3/36

(52) U.S. Cl. 345/87

(57) ABSTRACT

An apparatus for driving a display unit of a mobile terminal comprises a display panel comprising rows and columns to display an image, a memory connected to the controller for storing display data representing the image, at least one column driver electronically connected to the display panel for controlling column pixels, first and second row drivers each electronically connected to a row segment comprising at least one row of the display panel, a timing controller in communication with the at least one column driver and the first and second row drivers to control column and row addresses to control the image on the display panel, and a controller for controlling functional components of the mobile terminal.

### CROSS-REFERENCE TO RELATED APPLICATIONS

Pursuant to 35 U.S.C. § 119(a), this application claims the benefit of earlier filing date and right of priority to Korean Patent Application No. 10-2003-70005, filed on Oct. 8, 2003 and 10-2003-71143, filed on Oct. 13, 2003, the content of which is hereby incorporated by reference herein in its entirety.

### BACKGROUND OF THE INVENTION

1. Field of the Invention

The present invention relates to a mobile terminal and, more particularly, to a system and method for driving a display panel of a mobile terminal with enhanced picture quality.

2. Description of the Related Art

Some mobile communication terminals are equipped with a color liquid crystal display that provides for displaying full color video reproduction of content. A camera may be also included to allow a user to photograph a still image or record a video. Some mobile terminals may also include a 64-chord sound card allowing the user to listen to music.

With introduction of the next-generation mobile communication system (IMT-2000), a mobile terminal display unit can better display images. The display unit of a mobile terminal adopts a thin film transistor-liquid crystal display (TFT-LCD) in which pixels are arranged vertically and horizontally and controlled according to a certain rule for visually displaying various image signals.

As shown in FIG. 1, the display driving unit of the related art mobile terminal includes a controller 10 for controlling the functional components of a mobile terminal. Also included are a graphic random access memory (GRAM) 20 for receiving graphic data from the controller 10, a column driver 30 for receiving the graphic data of the GRAM 20 and outputting the graphic data in the column order.

A timing controller 40 for outputting column and row address signals of a display panel 60 according to a control signal of the controller 10, a row driver 50 for controlling a row display state of an image signal outputted in the column order from the column driver 30 according to the row address signal, and a display panel 60 for displaying graphic data applied from the column driver 30 and the row driver 50 may be also included.

The controller 10 controls and monitors each function of the mobile terminal and outputs various operation information. Messages such as an SMS message or an MMS message and graphic data for example may be forwarded to the GRAM 20. The GRAM 20 stores the graphic data provided by the controller 10 in the display panel 60 by units of frame, and applies the graphic data to the column driver 30.

The column driver 30 outputs graphic data in units of frame applied from the GRAM 20 in a horizontal direction of the display panel 60 according to the column address signal provided by the timing controller 40. The column driver 30 is a source driver such as a source electrode, for example, and serves to apply a signal voltage to pixels through a signal line.

The row driver 50 disperses the frame unit of graphic data outputted in the horizontal direction to the display panel 60 by the column driver 30 in a vertical direction by using a row address. The row driver is a gate driver such as a gate electrode, for example, and serves to generate scan signals for sequentially selecting gate lines.

The display panel 60 includes a TFT array and a color filter substrate at each pixel that displays graphic data applied from the column driver 30 and the row driver 50. The TFT array includes a TFT and capacitor installed at each pixel and gate and data lines connecting the TFT and the capacitor in a matrix format. The gate line connects the row driver 50 and the data line connects the column driver 30.

FIG. 2 illustrates the display direction and order in a display unit of a related art mobile terminal, in which the display unit has 176 horizontal pixels in a row and 220 vertical pixels in a column. With reference to FIG. 2, 176 pixels are displayed in the first row, beginning with pixel number 001 (e.g., pixel appearing at the left upper most corner) to pixel number 176 (e.g., pixel appearing at the right upper most corner). Accordingly, 176 pixels fill each row, for a total of 220 rows. Each row is filled sequentially from left to right, as shown, and from top to bottom to display an image on the display unit.

FIG. 3 illustrates a timing state for an address signal outputted to a related art display unit, wherein the pixels are filled sequentially row by row, based on the timing signal, as described above. Unfortunately, due to transmission rate limitations, when an insufficient number of graphic bits are receive by the mobile terminal, a region of the display, particularly the lower portion of the display suffers from a low display quality relative the upper portion of the display. A system and method is needed that can overcome this problem.

### SUMMARY OF THE INVENTION

An object of the present invention is to provide a faster and efficient way to display image on a display panel of a mobile terminal.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, an apparatus for driving a display unit of a mobile terminal comprises a display panel comprising rows and columns to display an image; a memory for storing display data representing the image; at least one column driver electronically connected to the display panel for controlling column pixels; first and second row drivers each electronically connected to a row segment comprising at least one row of the display panel; a timing controller in communication with the at least one column driver and the first and second row drivers to control column and row addresses to control the image on the display panel; and a controller for controlling functional components of the mobile terminal, wherein the controller controls the timer controller and the memory. Preferably, the first row driver first processes the display data associated with substantially a center of the display panel and then moves in an upward direction, and the second row driver first processes the display data associated with substantially a center of the display panel and then moves towards a downward direction.

According to one aspect of the present invention, the controller outputs control information and the display data in a frame unit, and the memory stores the display data in a frame unit.

According to another aspect of the present invention, a number of rows being controlled by the first and second row drivers are equally divided. For example, the display panel comprises N rows and the first row driver controls 1 to N/2 rows and the second row driver controls (N/2+1) to N rows.

According to another aspect of the present invention, the first row driver and the second row driver control respective row addresses of the display panel on an alternating manner in response to the timing controller. Alternatively, the first row driver and the second row driver concurrently control respective row addresses of the display panel in response to the timing controller.

According to another embodiment of the present invention, an apparatus for driving display panels of a mobile terminal comprises first and second display panels, each comprising rows and columns to display an image; a memory for storing display data representing the image; at least one column driver electronically connected to the first and second display panels for controlling respective column pixels; at least one row driver electronically connected to a row segment of each of the first and second display panels to display the image on one of the first and second display panels; a timing controller in communication with the at least one column driver and the at least one row driver to control column and row addresses to control the image on the first and second display panels; and a controller for controlling functional components of the mobile terminal, wherein the controller controls the timer controller and the memory. Preferably, the at least one row driver comprise: a first row driver electronically connected to the first and second display panels; and a second row driver electronically connected to the first and second display panels, wherein a number of rows being controlled by the first and second row drivers are equally divided.

According to another embodiment of the present invention, a method for controlling a display panel of a mobile terminal comprises generating display data in a controller; storing the display data in a memory; providing the display data associated with column data to at least one column driver; providing the display data associated with row data to a plurality of row drivers; generating column addresses using the column data in response to a timing controller; generating row addresses using the row data in response to the timing controller; and displaying the display data on the display panel in response to the column addresses and the row addresses from the column driver and the plurality of row drivers, respectively. The plurality of row drivers comprises a first row driver and a second row driver, wherein the first row driver first processes the display data associated with substantially a center of the display panel and then moves towards an upward direction.

According to yet another embodiment of the present invention, a method for controlling at least two display panels of a mobile terminal comprises generating display data in a controller; storing the display data in a memory; providing the display data associated with column data to at least one column driver; providing the display data associated with row data to first and second row drivers; generating column addresses using the column data in response to a timing controller; generating row addresses using the row data in response to the timing controller; and displaying the display data on one of first and second display panels in response to the column addresses and the row addresses from the column driver and the first and second row drivers, respectively. Preferably, the first row driver processes the display data associated with substantially a center of the display panels and then moves to an upward direction, and the second row driver first processes the display data associated with substantially a center of the display panel and then moves towards a downward direction.

It is to be understood that both the foregoing general description and the following detailed description are exemplary and explanatory and are intended to provide a further explanation of the invention as claimed.

### BRIEF DESCRIPTION OF THE DRAWINGS

The invention will be described in detail with reference to the following drawings in which like reference numerals refer to like elements.

FIG. 1 illustrates a structure of related art display driving apparatus of a mobile terminal.

FIG. 2 illustrates display direction and order for a display panel of the related art system.

FIG. 3 illustrates timing states of address signals outputted to the display panel according to a related art display driving method.

FIG. 4 illustrates is a block diagram for a display driving apparatus of a mobile terminal in accordance with a preferred embodiment of the present invention.

FIG. 5 illustrates direction and order of display of pixels on a panel of a mobile terminal, in accordance with one embodiment of the present invention.

FIG. 6 illustrates output timing states for sequentially displaying pixels in accordance with one embodiment of the present invention.

FIG. 7 is a flow chart of a display driving method of a mobile terminal in accordance with one embodiment of the present invention.

FIG. 8 illustrates a direction and order of display of pixels on a panel of a mobile terminal, in accordance with another embodiment of the present invention.

FIG. 9 illustrates output timing states for sequentially displaying pixels simultaneously in two rows, in accordance with another embodiment of the present invention.

FIG. 10 is a flow chart of a display driving method of a mobile terminal in accordance with another embodiment of the present invention.

FIG. 11 illustrates a block diagram for a display driving apparatus of a mobile terminal in accordance with a second embodiment of the present invention.

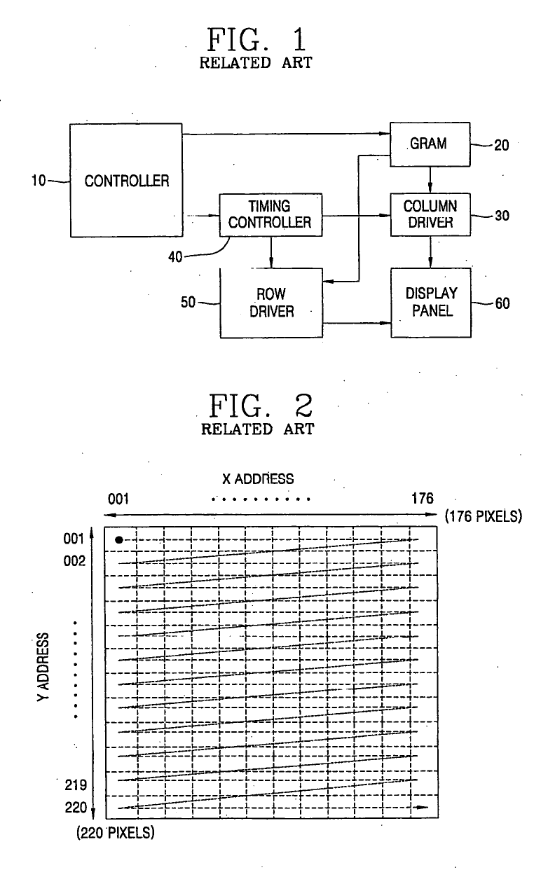

### DETAILED DESCRIPTION OF THE PREFERRED EMBODIMENTS

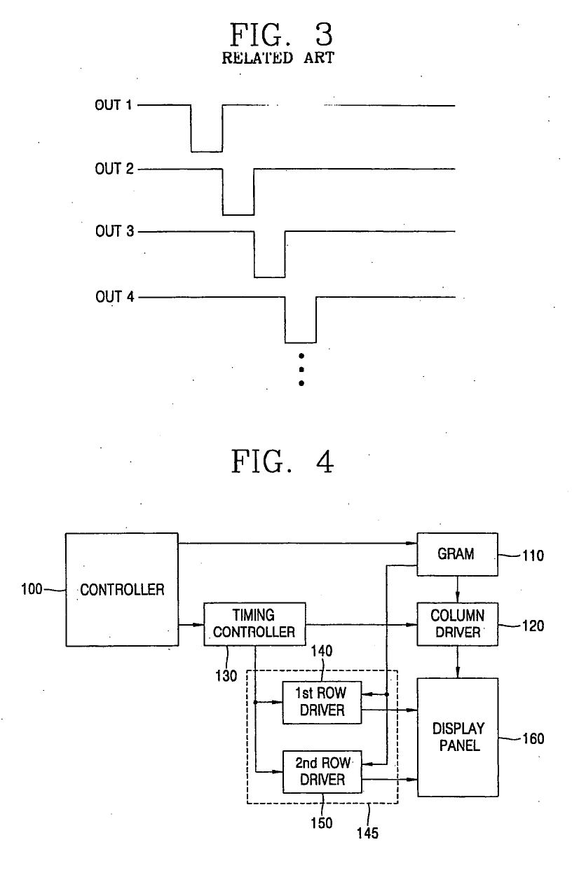

Referring to FIG. 4, in accordance with one aspect of the invention, a display driver of a mobile terminal comprises a controller 100 for controlling and monitoring one or more components of a mobile terminal and outputting various operation information and messages. Controller 100 also controls and outputs graphic data according to an image signal sent to a memory or GRAM 110. The GRAM 110 stores graphic data in frame units to be displayed on a display panel 160. In image processing, a frame is data for completing one full screen or its equivalent storage space.

The display driver further comprises a column driver 120 for receiving the graphic data of the GRAM 110 and outputting the data column by column. A timing controller 130 for outputting column and first and second row address signals for the display panel 160 according to a control signal of the controller 100 may be also included in one embodiment.

A first row driver 140 for controlling a row display state of an image signal outputted in order of column from the column driver 120 according to the first row address signal is provided. The display driver of a mobile terminal in accordance with the preferred embodiment of the present invention comprises a plurality of row drivers, preferably two row drivers.

As such, a second row driver 150 for controlling a row display state of an image signal outputted in order of column from the column driver 120 according to the second row address signal is also provided. The display panel 160 displays the graphic data applied by the column driver 120 and the first and second row drivers 140 and 150.

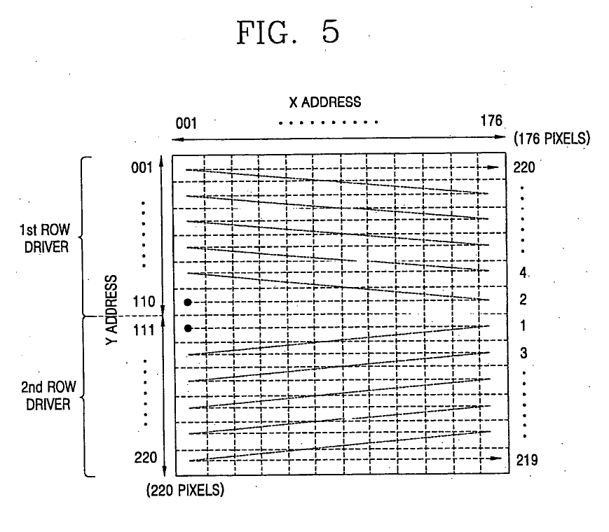

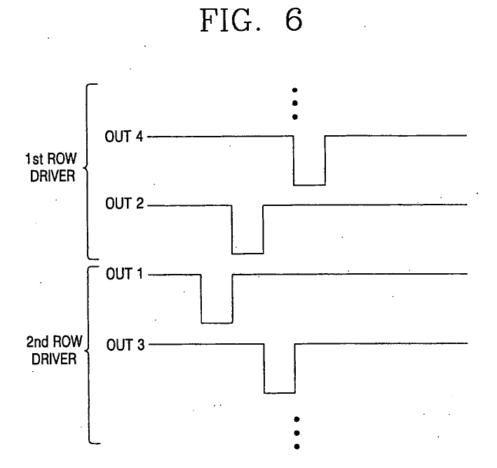

Referring to FIG. 5, the present invention utilizes two row drivers 140 and 150 to generate a display starting with two rows in the middle of the display panel 160. Additional rows are displayed sequentially toward the top and bottom of the display. In one embodiment, the pixels are alternately displayed one row at a time in the upper and lower portions of the display, respectively. In another embodiment, the lines at the upper portion and the lower portion are simultaneously displayed.

As shown in FIG. 5, in the first embodiment, the display starts from a first column of rows 110 and 111 in a central region of the display panel 160 that divides the display panel 160 into upper and lower regions. The upper region is preferably controlled by the first row driver 140, and the second region is preferably controlled by the second row driver 150.

In an exemplary embodiment, first one line from the first column 001 to the last column 176 for the row 111 is displayed. Then, one line from the first column 001 to the last column 176 for the row 110 is displayed. Then, one line from the column 001 to the column 176 for the row 112 is displayed and one line from the column 001 to the column 176 for the row 109 is displayed, for example. In this manner, pixels are sequentially displayed in each row of the upper and lower region of the display panel 160, respectively, such that both upper and lower regions are painted simultaneously.

In the above description, the second row driver is driven first. In an alternative embodiment, the first row driver can be driven first instead. Thus, the order in which the first or second row drivers are driven can changed depending on the implementation.

In accordance with one embodiment, a specific bit of the LCD driver control command is set to determine a shift direction. With reference to FIG. 6, for example, the first outputted row address is OUT1 outputted from the second row driver, and the next outputted row address is OUT2 outputted from the first row driver.

The next outputted row address is OUT3 outputted from the second row driver, and the next outputted row address is OUT4 outputted from the first row driver, for example. The alternately and sequentially outputted timing signals are continuously generated until all row addresses are all outputted for each frame, in accordance with one embodiment.

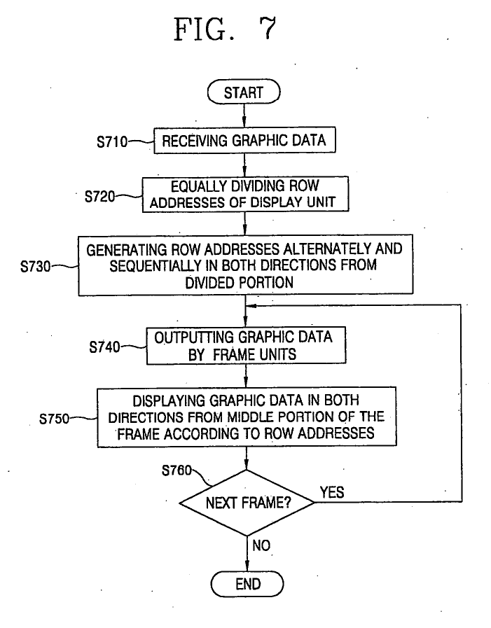

Referring to FIG. 7, a display driving method for a mobile terminal in accordance with one embodiment of the present invention is provided. The method comprises receiving graphic data from a controller and storing it in a GRAM. In one embodiment, the timing controller equally divides row addresses and applying one half of row addresses to the first row driver, the other half to the second row driver, and column addresses to a column driver generating the first and second row addresses and alternately sequentially from the middle portion of a display panel to an upper end and to a lower end.

The column driver outputs the graphic data to the display panel according to the column addresses, and the display panel alternately and sequentially outputs the graphic data by units of column applied from the column driver in both directions of up and down from the middle portion of the frame according to row addresses applied from the first and second row drivers.

In one embodiment, when the graphic data displayed on the display panel is inputted, the controller records and stores the graphic data in the GRAM (S710). Next, the controller equally divides rows and generates row addresses constituted at the display panel by controlling the timing controller, and applies the generated row addresses to the first and second row drivers (S720). Upon receiving the row addresses, the first and second row drivers output row addresses, which are alternately sequentially driven from the middle portion of the display panel to both upper and lower end (S730).

The column driver outputs graphic data in units of column suitable for pixels to the display panel (S740). For example, in case of 176×220 pixels per panel (i.e., per frame), graphic data in units of frame is outputted as 176 column units. In one embodiment, the display panel alternately and sequentially outputs the graphic data in units of column according to the column driver from the middle portion of the frame in up and down directions according to row addresses provided by the first and second row drivers (S750).

When displaying is completed for every pixel in the frame, it is determined whether a different frame is displayed (S760). If so, additional graphic data is generated.

In accordance with a second embodiment, the display unit driving method for displaying pixels simultaneously by two lines up and down in a mobile terminal in accordance with another embodiment of the present invention is provided.

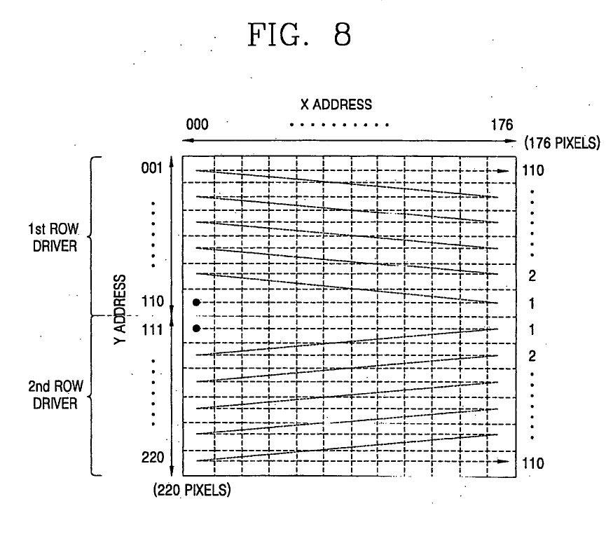

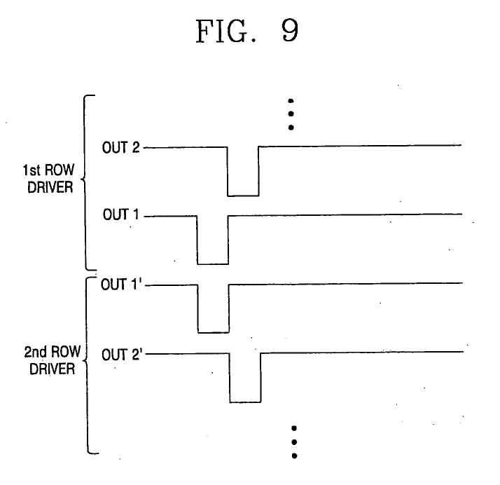

As shown in FIG. 8, display starts from a first column of a row 110 and a row 111 in the central portion of the display, and extends up and down. In this embodiment, two lines of both upper portion and lower portion are simultaneously displayed. One line of the first column 001 of the row 110 is displayed in association with the first row driver to the last column 176; and one line from the first column 001 to the last column 176 for the row 111 is displayed in association with the second row driver are simultaneously displayed.

Next, one line from the column 001 to the column 176 for the row 109 of the first row driver region and one line from the column 001 to the column 176 for the row 112 of the second row driver region are simultaneously displayed. In this manner, two lines of the upper portion and the lower portion are simultaneously displayed.

FIG. 9 illustrates output timing states for sequentially displaying pixels simultaneously by two lines in accordance with the second embodiment of the present invention, wherein the first outputted row address is OUT1 outputted from a first row driver and OUT1′ outputted from the second row driver. The next outputted row address is OUT2 outputted from the first row driver and OUT2 outputted from the second row driver. This sequentially and simultaneously outputted timings are generated made until row addresses by units of frame are all outputted.

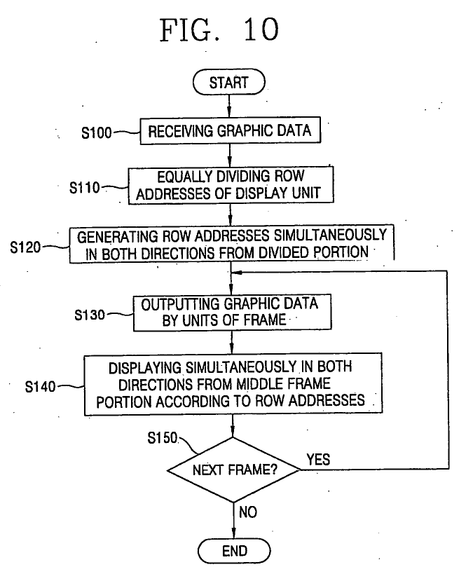

FIG. 10 is a flow chart of a display unit driving method of a mobile terminal in accordance with the second embodiment of the present invention. The method comprises receiving graphic data from a controller and recording and storing it in a GRAM. The timing controller equally divides row addresses and assigns one half of row addresses to the first row driver, the other half to the second row driver.

The timing controller also assigns column addresses to a column driver. The first and second row drivers output row addresses which are driven simultaneously row by row from the central portion of the display panel respectively to an upper end and to a lower end. The column driver outputs graphic data to the display panel according to the column addresses.

The display panel outputs the graphic data column by column as assigned to the column driver and line by line simultaneously in both up and down directions from the middle portion of the frame according to row addresses provided by the first and second row drivers.

When the graphic data is inputted, the controller records and stores the data in the GRAM (S100). Next, the controller equally divides rows and generates row addresses for the display panel by controlling the timing controller, and assigns the generated row addresses to the first and second row drivers (S110).

Upon receiving the row addresses, the first and second row drivers generate row addresses, which are simultaneously driven row by row from the middle portion of the display panel in both upper and lower ends of the display (S120). At the same time, the column driver outputs graphic data in units of frame to the display panel (S130).

In one embodiment, the display panel outputs the graphic data in units of column as applied from the column driver simultaneously row by row from the middle portion of the frame in both up and down directions according to row addresses as applied from the first and second row drivers (S140). When every pixel in a frame is displayed, it is determined whether more graphic data is to be displayed (S150). If another frame is to be displayed, then additional graphic data is outputted on the display panel.

The display driving apparatus and method of a mobile terminal in accordance with the present invention have the following advantages. Because graphic data is preferably displayed from the central region of the display panel by using two row drivers driving the display unit of the mobile terminal, the central portion is not affected by noise. In addition, even if bits are not enough in controlling a transmission rate, since the central portion is minimally affected, a picture quality of the central portion can be improved or at least not affected, and thus, users can feel enhancement of the picture quality. In addition, when displaying real time video segments (for example, video conferencing), the image displayed is from the middle rather than from the top so that even if the video scene is changed before the entire image is displayed, a main gist of the image is shown (which is usually located in the center of the display) to the user.

It is noteworthy that, while one or more embodiments of the invention are described as applicable to a system environment comprising a plurality of row drivers, other embodiments of the invention may be implemented to comprise a plurality of column drivers instead or in conjunction with the plurality of row drivers.

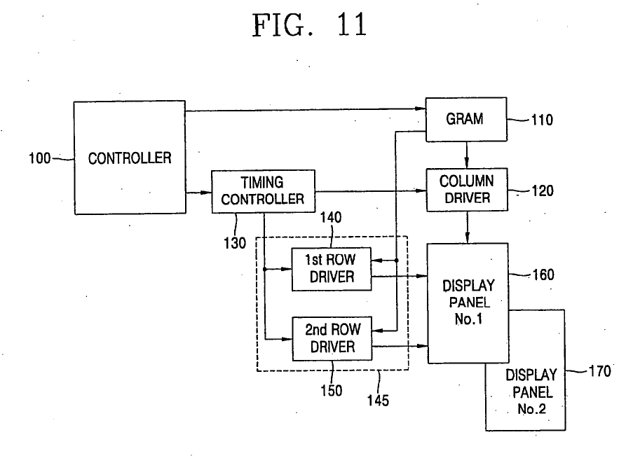

FIG. 11 illustrates a block diagram for a display driving apparatus of a mobile terminal in accordance with a second embodiment of the present invention. This embodiment is useful for a mobile terminal that has two or more displays for showing images. Preferably, such mobile terminal has external displays and internal displays which are used exclusive to each other. In other words, when a flip-type mobile terminal is closed, then the external display is enabled, and when the mobile terminal is opened, then the internal display is enabled while the external display is disabled.

Referring to FIG. 11, a display driver of a mobile terminal comprises a controller 100, a GRAM 110, a column driver 120, a timing controller 130, a row driver unit 145, and display panels 160 and 170. The row driver unit 145 comprises first row driver 140 and the second row driver 150. Display panel 160 may represent an internal display of the mobile terminal; and display panel 170 may represent an external display of the mobile terminal.

The first and second row drivers 140 and 150 control a row display state of an image signal. The display panels 160, 170 display the display data applied by the column driver 120 and the first and second row drivers 140 and 150. Accordingly, in the second embodiment of the invention, the same first and second row drivers 140 and 150 control two display panels 160 and 170, thus eliminating the use of two different sets of row drivers to drive two display panels. For example, when the first display panel 160 is enabled, then the first and second row drivers 140 and 150 control the row display of the first display panel 160. When the second panel 160 is enabled, then the first and second row drivers 140 and 150 control the row display of the second display panel 170. Preferably, images are displayed from the center of the display panel and moves upward and downward as shown in FIG. 5.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

1. An apparatus for driving a display unit of a mobile terminal, the apparatus comprising:
a display panel comprising rows and columns to display an image;
a memory for storing display data representing the image;
at least one column driver electronically connected to the display panel for controlling column pixels;
first and second row drivers each electronically connected to a row segment comprising at least one row of the display panel;
a timing controller in communication with the at least one column driver and the first and second row drivers to control column and row addresses to control the image on the display panel; and
a controller for controlling functional components of the mobile terminal, wherein the controller controls the timer controller and the memory,
wherein the first row driver first processes the display data associated with substantially a center of the display panel and then moves in an upward direction.

2. The apparatus of claim 1, wherein the controller outputs control information and the display data in a frame unit.

3. The apparatus of claim 1, wherein the memory stores the display data in a frame unit.

4. The apparatus of claim 1, wherein a number of rows being controlled by the first and second row drivers are equally divided.

5. The apparatus of claim 1, wherein the display panel comprises N rows and the first row driver controls 1 to N/2 rows and the second row driver controls (N/2+1) to N rows.

6. The apparatus of claim 1., wherein the first row driver and the second row driver control respective row addresses of the display panel on an alternating manner in response to the timing controller.

7. The apparatus of claim 1, wherein the first row driver and the second row driver concurrently control respective row addresses of the display panel in response to the timing controller.

8. The apparatus of claim 1, wherein the second row driver first processes the display data associated with substantially a center of the display panel and then moves towards a downward direction.

9. An apparatus for driving display panels of a mobile terminal, the apparatus comprising:
first and second display panels, each comprising rows and columns to display an image;
a memory for storing display data representing the image;
at least one column driver electronically connected to the first and second display panels for controlling respective column pixels;
at least one row driver electronically connected to a row segment of each of the first and second display panels to display the image on one of the first and second display panels;
a timing controller in communication with the at least one column driver and the at least one row driver to control column and row addresses to control the image on the first and second display panels; and
a controller for controlling functional components of the mobile terminal, wherein the controller controls the timer controller and the memory.

10. The apparatus of claim 9, wherein the at least one row driver comprise:
a first row driver electronically connected to the first and second display panels;
a second row driver electronically connected to the first and second display panels, wherein a number of rows being controlled by the first and second row drivers are equally divided.

11. The apparatus of claim 10, wherein the first row driver and the second row driver control respective row addresses of one of the first and second display panels on an alternating manner in response to the timing controller.

12. The apparatus of claim 10, wherein the first row driver and the second row driver concurrently control respective row addresses of one of the first and second display panels in response to the timing controller.

13. The apparatus of claim 10, wherein the first row driver first processes the display data associated with substantially a center of the display panel and then moves towards an upward direction.

14. The apparatus of claim 10, wherein the second row driver first processes the display data associated with substantially a center of the display panel and then moves towards a downward direction.

15. A method for controlling a display panel of a mobile terminal, the method comprising:
generating display data in a controller;
storing the display data in a memory;
providing the display data associated with column data to at least one column driver;
providing the display data associated with row data to a plurality of row drivers;
generating column addresses using the column data in response to a timing controller;
generating row addresses using the row data in response to the timing controller; and
displaying the display data on the display panel in response to the column addresses and the row addresses from the column driver and the plurality of row drivers, respectively,
wherein the plurality of row drivers comprises a first row driver and a second row driver, wherein the first row driver first processes the display data associated with substantially a center of the display panel and then moves towards an upward direction.

16. The method of claim 15, wherein the display panel comprises N rows and the first row driver controls 1 to N/2 rows and the second row driver controls (N/2+1) to N rows.

17. The method of claim 15, wherein the first row driver and the second row driver control respective row addresses of the display panel on an alternating manner in response to the timing controller.

18. The method of claim 15, wherein the first row driver and the second row driver concurrently control respective row addresses of the display panel in response to the timing controller.

19. The method of claim 15, wherein a number of rows being controlled by the first and second row drivers are equally divided.

20. The method of claim 15, wherein the second row driver first processes the display data associated with substantially a center of the display panel and then moving towards a downward direction.

21. A method for controlling at least two display panels of a mobile terminal, the method comprising:
generating display data in a controller;
storing the display data in a memory;
providing the display data associated with column data to at least one column driver;
providing the display data associated with row data to first and second row drivers;
generating column addresses using the column data in response to a timing controller;
generating row addresses using the row data in response to the timing controller; and
displaying the display data on one of first and second display panels in response to the column addresses and the row addresses from the column driver and the first and second row drivers, respectively, wherein the first row driver processes the display data associated with substantially a center of the display panels and then moves to an upward direction.

22. The method of claim 21, wherein the first row driver and the second row driver control respective row addresses of one of the first and second display panels on an alternating manner in response to the timing controller.

23. The method of claim 21, wherein the first row driver and the second row driver concurrently control respective row addresses of one of the first and second display panels in response to the timing controller.

24. The method of claim 21, wherein a number of rows being controlled by the first and second row drivers are equally divided.

25. The method of claim 21, wherein the second row driver first processes the display data associated with substantially a center of the display panel and then moves towards a downward direction.
